(19) United States
(12) Patent Application Publication
(10) Pub. No.: US 2009/0322806 A1
(43) Pub. Date: Dec. 31, 2009

(54) METHOD OF PRINTING FOR INCREASED INK EFFICIENCY

(76) Inventors: Frederick A. Donahue, Walworth, NY (US); R. Winfield Trafton, Brockport, NY (US); Gary A. Kneezel, Webster, NY (US)

Correspondence Address: David A. Novais;Patent Legal Staff, Eastman Kodak Company, 343 State Street, Rochester, NY, 14650-2201, US

(21) Appl. No.: 12/146,484

(22) Filed: Jun. 26, 2008

(51) Int. Cl. B41J 2/195

(52) U.S. Cl. 347/7

(57) ABSTRACT

The present invention relates generally to the field of inkjet printing, and in particular to a method of printing that provides improved ink usage efficiency. In the method of the present invention a threshold level of ink in an ink chamber or reservoir is stored. The remaining amount of ink in the ink chamber or reservoir is monitored and compared to the threshold level. When the remaining amount of ink in the ink chamber or reservoir is below the threshold level, an ink throughput through the printhead for a printed image is reduced.

### CROSS REFERENCE TO RELATED APPLICATIONS

Reference is made to commonly-assigned, U.S. patent application Ser. No. ______ (D. 95073) filed ______ entitled DROP VOLUME COMPENSATION FOR INK SUPPLY VARIATION in the name of Gary Kneezel et al. incorporated herein by reference.

### FIELD OF THE INVENTION

The present invention relates generally to the field of inkjet printing, and in particular to a method of printing that provides improved ink usage efficiency.

### BACKGROUND OF THE INVENTION

Inkjet printing systems generally include ink supplies which must be replaced after the ink has been consumed due to printing and also due to printhead maintenance operations. It is advantageous to use the ink efficiently in order to decrease the cost per print. In some ink delivery systems for printers, the ink usage efficiency is decreased under certain usage conditions, because an amount of ink becomes trapped in the ink supply and cannot be delivered to the printhead.

Inkjet printing systems generally include a pressure regulator to maintain an appropriate range of negative fluidic pressure at the printhead nozzles so that the ink does not leak from the printhead nozzles, but also so that ink can be delivered to the printhead at required flow rates. One type of pressure regulator that is used is a porous medium that stores ink in the ink tank. In this case, capillary forces provide the required range of negative pressures. Ink tanks that store ink in a porous medium are an example of a type of ink supply that can be susceptible to trapping of ink within the porous medium, such that a premature end of life occurs for the tank. It has been observed that high flow rates from the tank can result in ink trapping and excessive negative pressure, and especially if a significant amount of ink has already been depleted from the tank.

What is needed is a method of printing that results in a lower amount of ink trapping, and thereby a higher ink usage efficiency.

### SUMMARY OF THE INVENTION

The present invention relates to a printing method that lowers the amount of ink trapped in, for example, a porous medium and increases ink usage efficiency.

The present invention accordingly relates to a method of printing comprising: providing a printhead in fluid communication with an ink chamber or reservoir; setting and storing a threshold level of ink in the ink chamber; monitoring a remaining amount of ink in the ink reservoir; comparing the remaining amount of ink in the ink chamber with the threshold level; and adjusting an ink throughput through the printhead for a printed image when the remaining amount of ink in the ink chamber is below the threshold level.

The present invention further relates to a method of printing comprising: providing a printhead in fluid communication with an ink chamber or reservoir; setting and storing a threshold level of ink in the ink chamber; monitoring a remaining amount of ink in the ink chamber; comparing the remaining amount of ink in the ink reservoir with the threshold level; detecting an ink demand of at least a portion of an image to be printed; storing a set value of the detected ink demand; and adjusting an ink throughput through the printhead for a printed image when the remaining amount of ink in the ink chamber is below the threshold level and a detected ink demand exceeds the set value.

The present invention further relates to a method of printing comprising: providing a printhead in fluid communication with a plurality of ink chambers or reservoirs; setting and storing a threshold level for ink in each of the plurality of ink chambers; monitoring a remaining amount of ink in each of the plurality of ink chambers; comparing the remaining amount of ink in each of the plurality of ink chambers to a corresponding threshold level for the ink chamber; and adjusting an ink throughput through the printhead for a printed image when the remaining amount of ink in one of the plurality of ink chambers is decreased below its corresponding threshold level.

The present invention further relates to a method of printing comprising: providing a printhead in fluid communication with an ink chamber or reservoir; setting and storing a threshold level of ink in the ink chamber; detecting an ink demand of at least a portion of an image to be printed; storing a set value of the detected ink demand; and adjusting an ink throughput through the printhead for a printed image when a detected ink demand exceeds the set value.

### BRIEF DESCRIPTION OF THE DRAWINGS

FIG. 1 is a schematic representation of an inkjet printer system.

FIG. 2 is a perspective view of a portion of a printhead.

FIG. 3 is a perspective view of a portion of a carriage printer.

FIG. 4 is a perspective view of a portion of a printhead rotated relative to FIG. 2.

FIG. 5 is a perspective view of a multichamber ink tank.

FIG. 6 is a perspective view of a portion of a printhead chassis with ink tanks removed.

FIG. 7 is a schematic representation of an ink tank chamber having a porous medium that is nearly full of ink.

FIG. 8 is a schematic representation of an ink tank chamber that has been substantially uniformly depleted of ink.

FIG. 9 is a schematic representation of a partially depleted ink tank chamber having isolated regions of trapped ink.

FIG. 10 is a schematic representation of a more fully depleted ink tank chamber having isolated regions of trapped ink.

FIG. 11 is a schematic representation of the effect of ink chamber fill level and flow rate on negative pressure.

FIG. 12 is a plot of exemplary data of negative pressure versus flow rate from an ink tank chamber for various ink fill levels.

FIG. 13 is a plot of exemplary data of usable ink efficiency versus flow rate.

### DETAILED DESCRIPTION OF THE INVENTION

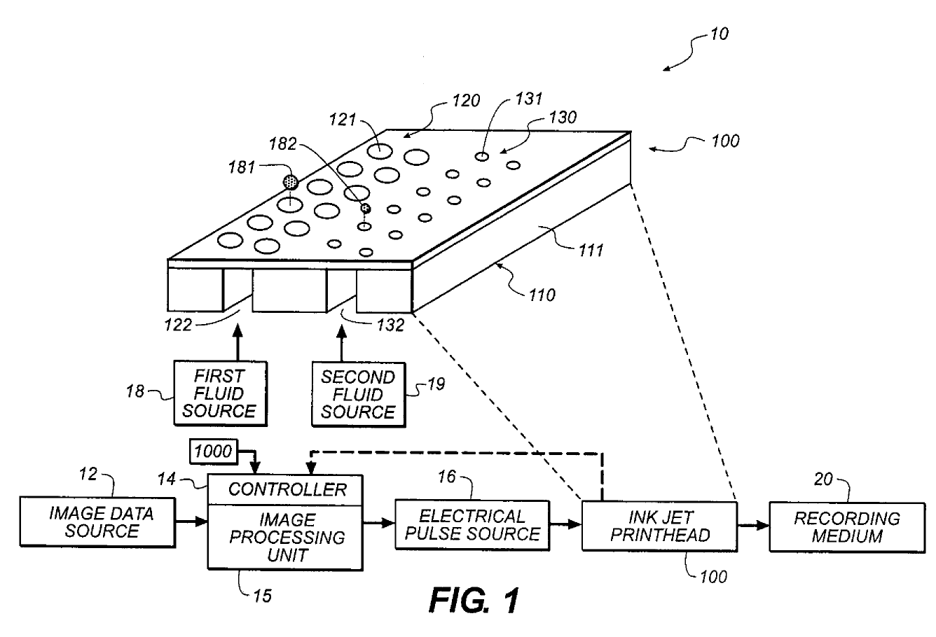

Referring to FIG. I, a schematic representation of an inkjet printer system 10 is shown, as described in U.S. Pat. No. 7,350,902. The system includes a source 12 of image data which provides signals that are interpreted by a controller 14 as being commands to eject drops. Controller 14 includes an image processing unit 15 for rendering images for printing, and outputs signals to a source 16 of electrical energy pulses that are inputted to the inkjet printhead 100 which includes at least one printhead die 110. In the example shown in FIG. 1, there are two nozzle arrays. Nozzles 121 in the first nozzle array 120 have a larger opening area than nozzles 131 in the second nozzle array 130. In this example, each of the two nozzle arrays has two staggered rows of nozzles, each row having a nozzle density of 600 per inch. The effective nozzle density then in each array is 1200 per inch. If pixels on the recording medium were sequentially numbered along the paper advance direction, the nozzles from one row of an array would print the odd numbered pixels, while the nozzles from the other row of the array would print the even numbered pixels.

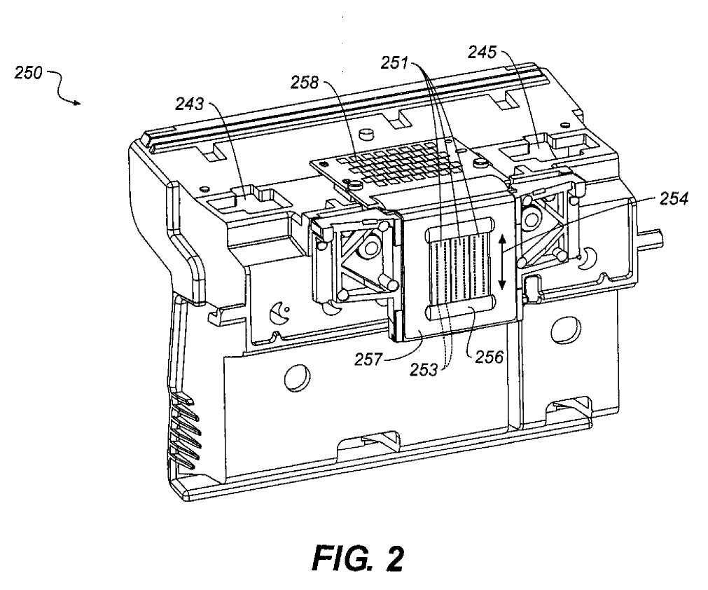

In fluid communication with each nozzle array is a corresponding ink delivery pathway. Ink delivery pathway 122 is in fluid communication with nozzle array 120, and ink delivery pathway 132 is in fluid communication with nozzle array 130. Portions of fluid delivery pathways 122 and 132 are shown in FIG. 1 as openings through printhead die substrate 111. One or more printhead die 110 will be included in inkjet printhead 100, but only one printhead die 110 is shown in FIG. 1. The printhead die are arranged on a support member as discussed below relative to FIG. 2. In FIG. 1, first ink source 18 supplies ink to first nozzle array 120 via ink delivery pathway 122, and second ink source 19 supplies ink to second nozzle array 130 via ink delivery pathway 132. Although distinct ink sources 18 and 19 are shown, in some applications it may be beneficial to have a single ink source supplying ink to nozzle arrays 120 and 130 via ink delivery pathways 122 and 132 respectively. Also, in some embodiments, fewer than two or more than two nozzle arrays may be included on printhead die 110. In some embodiments, all nozzles on a printhead die 110 may be the same size, rather than having multiple sized nozzles on a printhead die.

Not shown in FIG. 1 are the drop forming mechanisms associated with the nozzles. Drop forming mechanisms can be of a variety of types, some of which include a heating element to vaporize a portion of ink and thereby cause ejection of a droplet, or a piezoelectric transducer to constrict the volume of a drop ejector chamber and thereby cause ejection, or an actuator which is made to move (for example, by heating a bilayer element) and thereby cause ejection. In any case, electrical pulses from pulse source 16 are sent to the various drop ejectors according to the desired deposition pattern. In the example of FIG. 1, droplets 181 ejected from nozzle array 120 are larger than droplets 182 ejected from nozzle array 130, due to the larger nozzle opening area. Typically other aspects of the drop forming mechanisms (not shown) associated respectively with nozzle arrays 120 and 130 are also sized differently in order to optimize the drop ejection process for the different sized drops. During operation, droplets of ink are deposited on a recording medium 20.

FIG. 2 shows a perspective view of a portion of a printhead chassis 250, which is an example of an inkjet printhead 100. Printhead chassis 250 includes three printhead die 251 (similar to printhead die 110), each printhead die containing two nozzle arrays 253, so that printhead chassis 250 contains six nozzle arrays 253 altogether. The six nozzle arrays 253 in this example may be each connected to separate ink sources (not shown in FIG. 2), such as cyan, magenta, yellow, text black, photo black, and a colorless protective printing fluid. Each of the six nozzle arrays 253 is disposed along direction 254, and the length of each nozzle array along direction 254 is typically on the order of 1 inch or less. Typical lengths of recording media are 6 inches for photographic prints (4 inches by 6 inches), or 11 inches for 8.5 by 11 inch paper. Thus, in order to print the fill image, a number of swaths are successively printed while moving printhead chassis 250 across the recording medium. Following the printing of a swath, the recording medium is advanced. The advance distance for single pass printing would be approximately 1ₙ. For N-pass multipass printing, the advance distance for the recording medium would be approximately 1ₙ/N. The total number of passes to print a sheet of recording media is thus approximately equal to NL/1_{N}. While a larger number N usually provides better print quality (because multiple nozzles are responsible for printing pixels within a line, so that defects due to malfunctioning nozzles are hidden), multipass printing also requires more total passes, so that printing throughput is reduced.

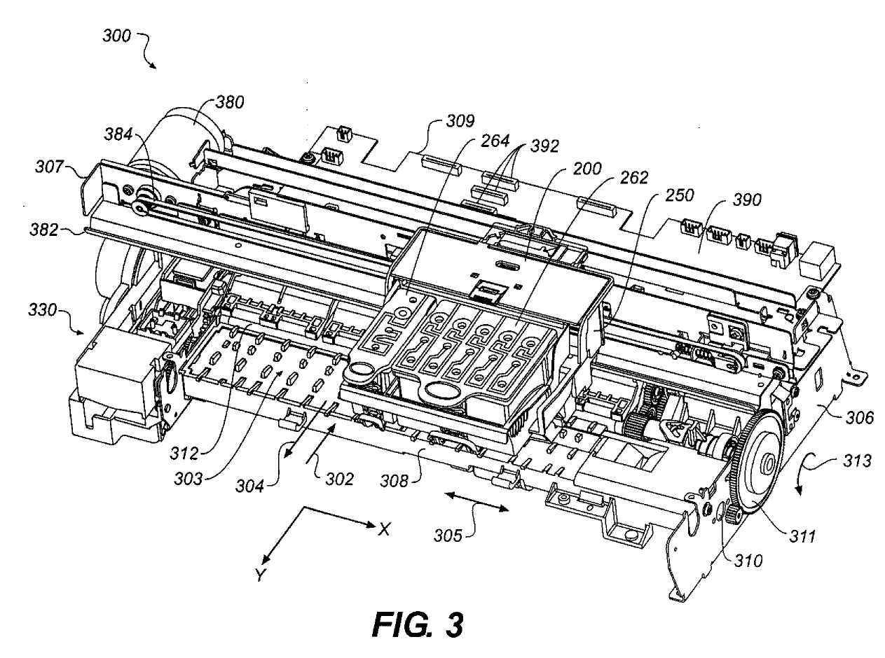

Also shown in FIG. 2 is a flex circuit 257 to which the printhead die 251 are electrically interconnected, for example by wire bonding or TAB bonding. The interconnections are covered by an encapsulant 256 to protect them. Flex circuit 257 bends around the side of printhead chassis 250 and connects to connector board 258. When printhead chassis 250 is mounted into a carriage 200 (see FIG. 3), connector board 258 is electrically connected to a connector (not shown) on the carriage 200, so that electrical signals may be transmitted to the printhead die 251.

FIG. 3 shows a portion of a carriage printer. Some of the parts of the printer have been hidden in the view shown in FIG. 3 so that other parts may be more clearly seen. Printer chassis 300 has a print region 303 across which carriage 200 is moved back and forth as shown by 305 along the X axis between the right side 306 and the left side 307 of printer chassis 300 while printing. Carriage motor 380 moves belt 384 to move carriage 200 back and forth along carriage guide rail 382. Printhead chassis 250 is mounted in carriage 200, and ink supplies 262 and 264 are mounted in the printhead chassis 250. The mounting orientation of printhead chassis 250 is rotated relative to the view in FIG. 2, so that the printhead die 251 are located at the bottom side of printhead chassis 250, the droplets of ink being ejected downward onto the recording media in print region 303 in the view of FIG. 3. Ink supply 262, in this example, contains five ink sources—cyan, magenta, yellow, photo black, and colorless protective fluid, while ink supply 264 contains the ink source for text black. Paper, or other recording media (sometimes generically referred to as paper herein) is loaded along paper load entry direction 302 toward the front 308 of printer chassis 300. A variety of rollers are used to advance the medium through the printer. For example, a pickup roller moves the top sheet of a stack of paper or other recording media in the direction of arrow 302.

A turn roller toward the rear 309 of the printer chassis 300 acts to move the paper around a C-shaped path (in cooperation with a curved rear wall surface) so that the paper continues to advance along direction arrow 304 from the rear 309 of the printer. The paper is then moved by feed roller 312 and idler roller(s) to advance along the Y axis across print region 303, and from there to a discharge roller and star wheel(s) so that printed paper exits along direction 304. Feed roller 312 includes a feed roller shaft along its axis, and feed roller gear 311 is mounted on the feed roller shaft. The motor that powers the paper advance rollers is not shown in FIG. 1, but the hole 310 at the right side 306 of the printer chassis 300 is where the motor gear (not shown) protrudes through in order to engage feed roller gear 311, as well as the gear for the discharge roller (not shown). For normal paper pick-up and feeding, it is desired that all rollers rotate in forward direction 313. Toward the left side 307 in the example of FIG. 3 is the maintenance station 330. Toward the rear 309 of the printer in this example is located the electronics board 390, which contains cable connectors 392 for communicating via cables (not shown) to the printhead carriage 200 and from there to the printhead. Also on the electronics board are typically mounted motor controllers for the carriage motor 380 and for the paper advance motor, a processor and/or other control electronics for controlling the printing process, and an optional connector for a cable to a host computer.

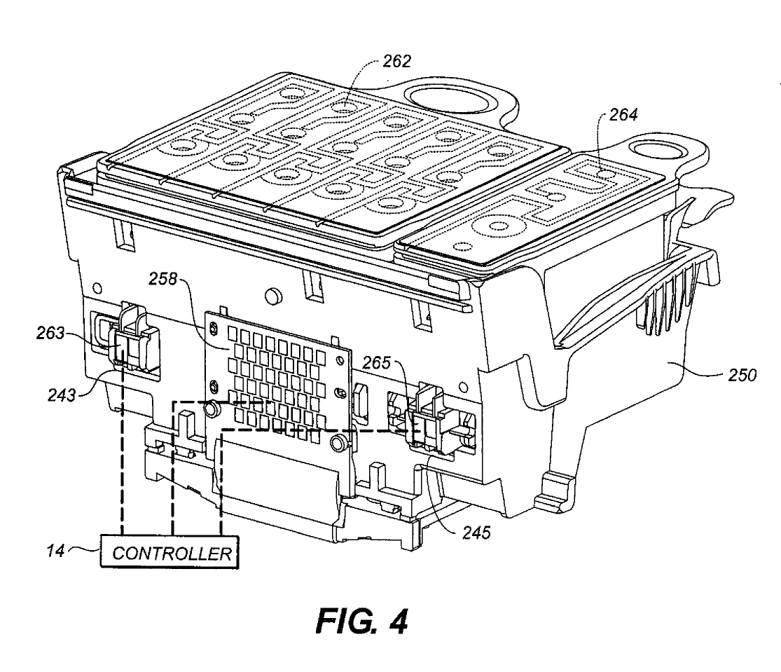

FIG. 4 shows a perspective view of printhead chassis 250 that is rotated relative to the view in FIG. 2. Replaceable ink tanks (multichamber ink tank 262 and single chamber ink tank 264) are shown mounted in printhead chassis 250. Multichamber ink tank 262 includes a memory device 263 and single chamber ink tank 264 includes a memory device 265. The memory devices 263 and 265 are typically used to provide information to controller 14 of the printer, and also to store data regarding the amount of ink that has been used from each chamber of the ink tank. Memory devices 263 and 265 protrude through holes 243 and 245 respectively in printhead chassis 250. In this way, contact pads on memory devices 263 and 265 and connector board 258 may easily be contacted by a connector in carriage 200, and from there through cables to cable connectors 392 on electronics board 390.

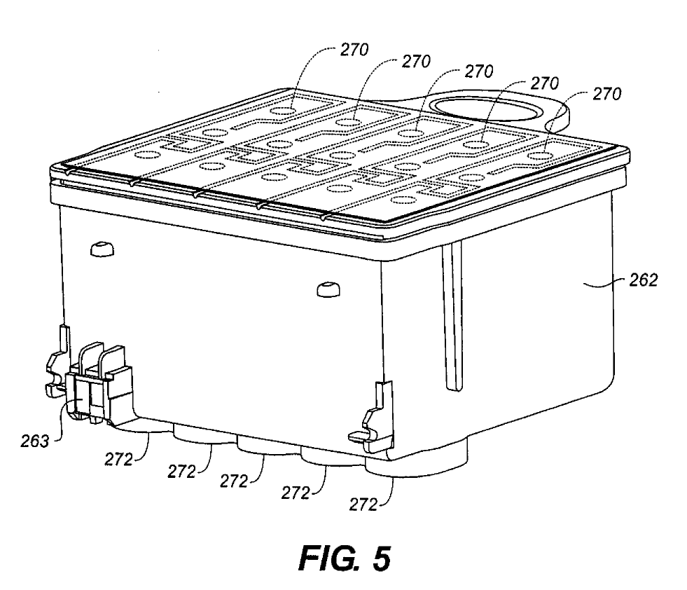

FIG. 5 shows a perspective view of multichamber ink tank 262 removed from printhead chassis 250. In this example, multichamber ink tank 262 has five chambers 270, and each chamber has a corresponding ink tank port 272 that is used to transfer ink to the printhead die 251.

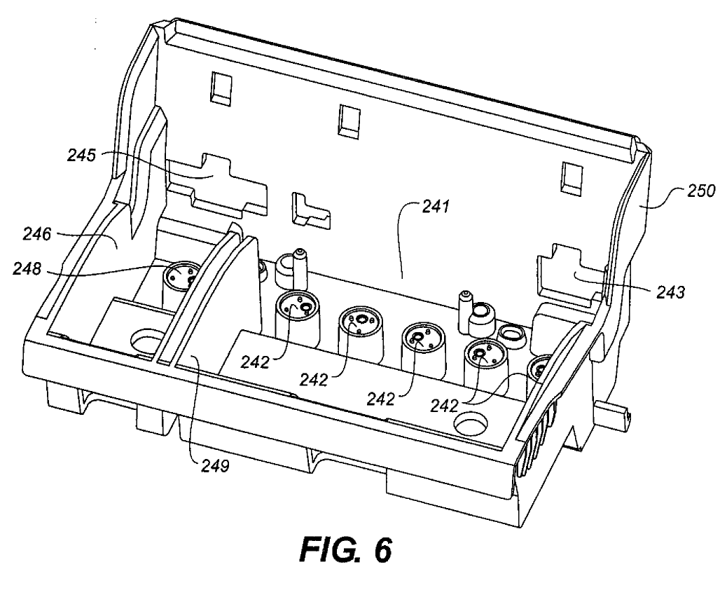

FIG. 6 shows a perspective view of printhead chassis 250 without either replaceable ink tank 262 or 264 mounted in it. Multichamber ink tank 262 is mountable in a region 241 and single chamber ink tank 264 is mountable in region 246 of printhead chassis 250. Region 241 is separated from region 246 by partitioning wall 249, which may also help guide the ink tanks during installation. Five ports 242 are shown in region 241 that connect with ink tank ports 272 of multichamber ink tank 262 when it is installed, and one port 248 is shown in region 246 for the ink tank port on the single chamber ink tank 264. The term ink reservoir will also be used herein interchangeably with ink tank. When an ink reservoir is installed in the printhead chassis 250, it is in fluid communication with the printhead because of the connection of ink tank port 272 with port 242 or 248.

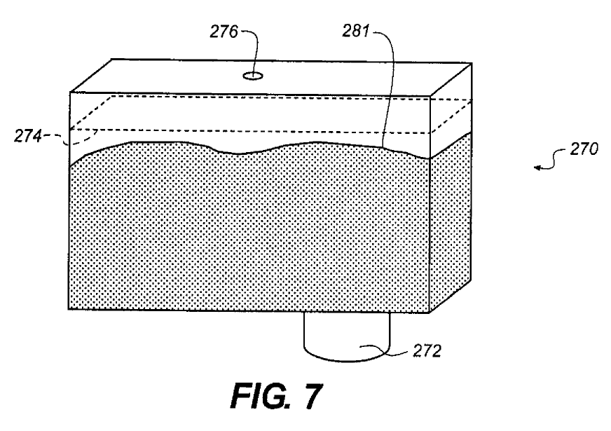

FIG. 7 shows a schematic representation of an ink tank chamber or reservoir 270 that is nearly filled with a porous capillary medium 274 that is saturated with ink in region 281, such that the chamber 270 contains nearly its full level of ink. Porous medium 274 may include materials such as foam, felt, stacked beads, or other such media having interstitial spaces into which fluid may be drawn by surface tension. When an ink tank containing chamber 270 is installed in printhead chassis 250 such that tank port 272 contacts a port 242 or 248, ink from chamber 270 may be drawn into the printhead chassis and to the corresponding printhead die 251. Optionally, upon installation, suction is applied at the face of printhead die 251 in order to start the flow and remove air bubbles that may have entered the printhead chassis prior to ink tank installation. Once a column of ink is established between the printhead die and the porous media 274, capillary forces in the porous media establish a negative pressure that forms a concave meniscus at the nozzles in corresponding nozzle array 253. The negative pressure is dependent upon the ink fill level in tank chamber 270. A tank chamber that is nearly empty of ink exerts a more highly negative pressure than a nearly full tank chamber does.

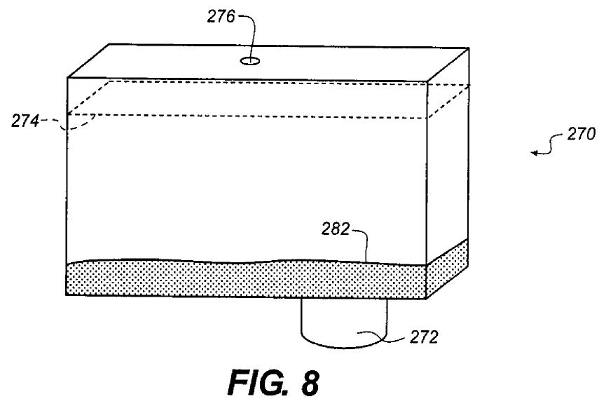

As ink is drawn from tank chamber 270 through tank port 272 due to printing or printhead maintenance operations, air enters a vent 276. Vent 276 is shown simply as a hole in the lid of the tank chamber 272, but typically the vent will include a winding path that will let air pass, but inhibits evaporation as well as liquid ink from leaking out of the tank chamber. FIG. 8 is a schematic representation of an ink tank chamber 272 where the ink has nearly been depleted from porous medium 274, such that region 282 of porous medium 274 that is saturated with ink is near the bottom of the tank chamber 270 where tank port 272 is located. FIG. 8 is an ideal example of uniform ink depletion from porous medium 274, with no ink being trapped in the region which has been depleted of ink.

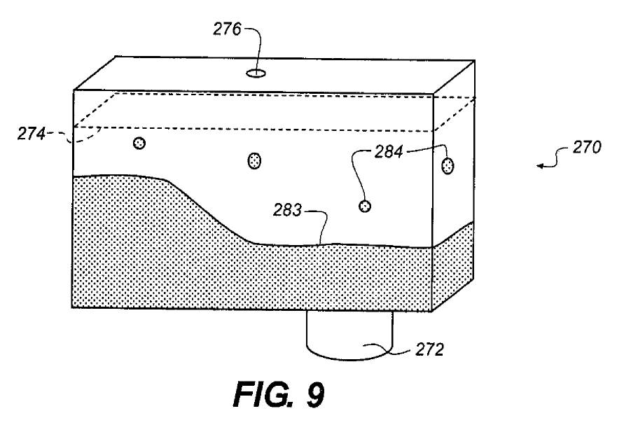

FIG. 9 is a schematic representation of a partially depleted ink tank chamber or reservoir 272 where region 283 is still saturated with ink, but several regions 284 in nonsaturated portion of porous medium 274 still have ink trapped in them. Once an ink-saturated region 284 is surrounded by air and has no liquid connection to the saturated region 283, there are no capillary forces that tend to draw ink in regions 284 toward tank port 272. Such ink will be wasted. While not being bound by theory, one reason for the formation of regions 284 of trapped ink is that the porous medium 272 is not completely uniform. There may be regions where the pores are different sizes, or there are more pores per volume, or there is a flow restriction. In addition, when the tank chamber 270 is filled with ink, small air bubbles (not shown) may be introduced within the nearly saturated region. Such nonuniformities disrupt the ink flow patterns. For example, if there is a blockage, such as an air bubble below a region of ink, the ink in that region must flow around the blockage. This takes additional time. Particularly if ink is being drawn through tank port 272 at a relatively high flow rate, neighboring regions deplete faster than the region above the blockage. As the pores in the depleted neighboring regions become filled with air rather than liquid, the region above the blockage can be isolated and the ink in that region becomes trapped.

It can be appreciated that a nearly full ink tank is less susceptible to trapping of ink than a partially depleted ink tank is, because there are more neighboring regions that can still connect to the partially blocked region and provide capillary forces to draw ink from the partially blocked region toward tank port 272. Another mechanism for ink trapping illustrated schematically in FIG. 9 is that ink in saturated regions that are closer to tank port 272 can be drawn out more quickly than ink in saturated regions that are farther from tank port 272, thus eventually isolating saturated regions that are remote from tank port 272.

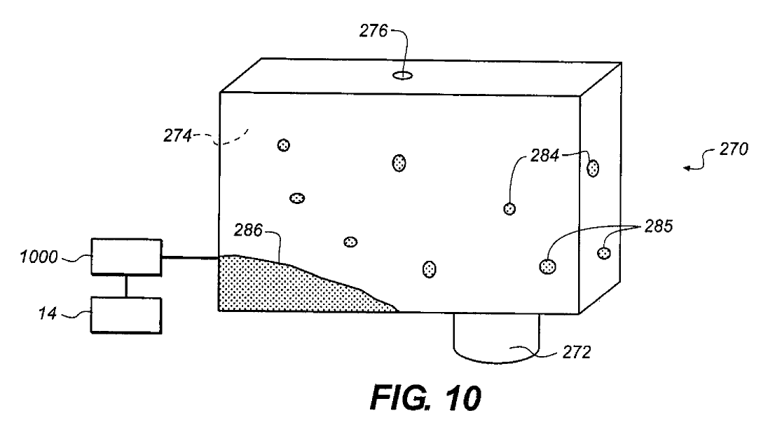

FIG. 10 is a schematic representation of an ink tank chamber 270 that is not fully depleted of ink, but having isolated regions of trapped ink 284 and 285 throughout porous medium 274, as well as a larger region of trapped ink 286 that is near the bottom of the tank chamber 270, but not near tank port 272. Regions 284 are the same as in FIG. 9, as they have not been able to move during subsequent depletion, while regions 285 are new regions of trapped ink as the tank has been further depleted. It is an object of the present invention to facilitate reducing the amount of ink that is trapped in an ink tank chamber, thus providing a more efficient usage of ink. The resulting longer ink tank lifetime not only can reduce the cost of printing, but also can result in less waste so that it is more eco-friendly.

As described above, ink chambers or reservoirs are particularly susceptible to trapping of ink in the porous medium when the flow rate is relatively high and when the tank chamber has been partially depleted of ink. In an embodiment of the present invention, both the ink demand and the remaining ink amount in the tank chamber are monitored, and the ink printing throughput is adjusted accordingly in order to inhibit the trapping of ink, thereby increasing the available amount of ink from the ink reservoir over the life of the ink reservoir. This is done in a way that does not decrease printing resolution or printing density, so that image quality of the printed image is preserved.

There are a variety of methods known in the art for monitoring the amount of ink that remains in an ink tank chamber or reservoir. Some of these methods use sensors, as schematically shown by reference numeral 1000 in FIG. 10, to measure the ink level in the tank chamber. Such sensors can include optical sensors that detect an optical characteristic of a transparent wall of the tank chamber, for example, that depends upon whether ink is present up to a certain level in the tank chamber. Other types of sensors include electrically resistive sensors in contact with a partially conductive ink, or capacitive sensors that sense a change in the capacitance with ink level. Other types of sensors involve a mechanical motion based on an amount of free ink in the tank chamber—for example by a float on the free ink, or by movement of a flexible tank chamber wall.

Indirect methods for monitoring the amount of ink remaining in a tank chamber have also been described. Such methods can involve counting of the drops that have been ejected for printing, and multiplying the number of drops by the drop volume. Such methods also may include counting the number of maintenance operations on the printhead that have occurred, and multiplying by the volume of ink required for the corresponding types of maintenance operations. Because it is known how much ink was put into the ink tank chamber during a filling operation, if the calculated amount of ink that has been used is subtracted from the original fill amount, an indication of the remaining ink is provided. For the purpose of this description, sensor 1000 is understood to refer to such indirect methods, or alternatively to a physical sensor as described in the paragraph above. The amount of ink that has been used (or correspondingly the amount of ink that remains) is sometimes stored in a memory device, such as 263 or 265 in FIGS. 4 and 5. The memory device may be mounted on the ink tank, so that even if the ink tank is removed from the printer and then reinserted, the printer controller 14 will recognize the ink tank and how much ink it contains in each tank chamber.

U.S. Pat. No. 6,517,175 considers how to improve the accuracy of drop counting for tracking the amount of ink remaining in the tank chamber. This patent recognizes that the drop volume ejected from a nozzle depends upon various operating conditions, including ink temperature, the amount of ink remaining in the tank chamber, the frequency of drop ejection, and the electrical pulse waveform provided to the drop ejector. It is well known that as ink temperature increases, the volume of the ejected drop increases. This can be attributed to lower ink viscosity. (In the case of thermal inkjet, not discussed in U.S. Pat. No. 6,517,175, a drop volume increase with temperature can also be attributed to the increased thermal energy content of the ink prior to bubble nucleation.) The effect on drop volume due to the amount of ink in the ink tank chamber is related to the amount of negative pressure exerted by the pressure regulating mechanism.

For pressure regulation provided by a porous medium in the ink tank chamber, a greater amount of negative pressure is provided as the tank chamber is depleted. As a result, the drop ejector is less completely filled with ink at the time of ejection, so that the drop volume is lower for a nearly empty ink tank chamber than it is for a nearly full ink tank chamber operating under otherwise identical operating conditions. Frequency of drop ejection can have an effect on drop volume, in that the drop ejector for a given nozzle may not have time to refill completely for high frequency drop ejection, and cross-talk due to firing of adjacent drop ejectors can also have an effect.

Finally, the drop volume can be affected by the waveform of the pulse applied to the drop ejector. As noted in U.S. Pat. No. 6,517,175, for piezoelectric drop ejectors it is possible to provide various sizes of drops (e.g. for large, medium and small dots) for various pixel locations in order to produce the desired image tones. Patent U.S. Pat. No. 6,517,175 discloses storing a set of correction factors related to ink temperature, amount of ink remaining in the tank chamber, and the dot pattern to be printed (related to drop ejection frequency and duty cycle). As disclosed in U.S. Pat. No. 6,517,175, the nominal quantity of each drop (large, medium, or small) can be corrected by the appropriate correction factor values depending on operating conditions, so that a more accurate drop counting estimate of the amount of ink ejected during printing is provided.

An object of the present invention is to increase the available amount of ink over the life of an ink reservoir by adjusting the ink throughput in the printhead depending on conditions such as a) the amount of ink remaining in an ink tank chamber, and/or b) the ink demand for printing an image. Both conditions a) and b) relate to the amount of negative pressure that is provided at the inkjet nozzles. With regard to condition a), a nearly empty ink tank chamber provides more negative pressure than a nearly full ink tank chamber due to increased capillary forces exerted by the nearly empty porous medium. With regard to condition b), the ink impedance of the fluid pathway between the ink reservoir and the printhead nozzles results in a larger pressure drop when a high flow rate is required than when a low flow rate is required.

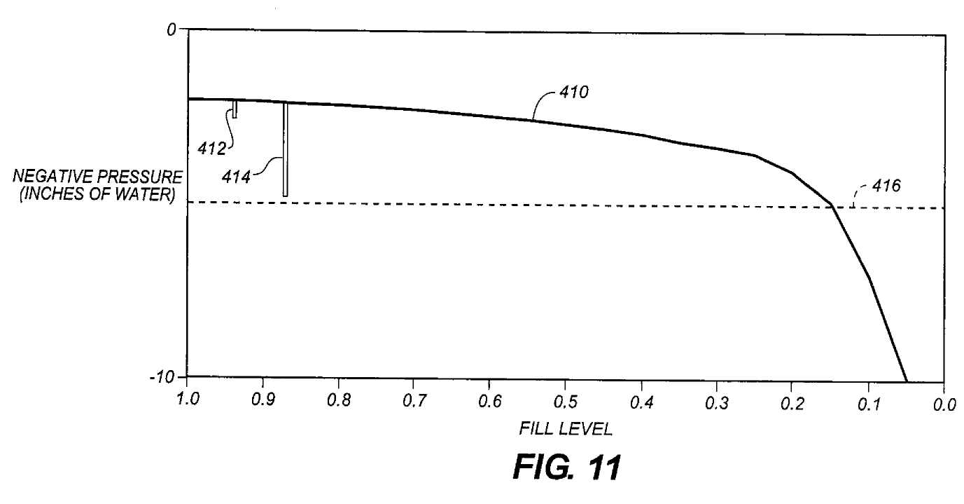

FIG. 11 schematically shows the effects of both conditions a) and b). Curve 410 shows an example of the static negative pressure versus ink fill level, where 1 corresponds to a full tank chamber and 0 corresponds to an empty tank chamber. In this particular example, the negative pressure starts out at −2 inches of water for a fill tank chamber and goes to −10 inches of water for an empty tank chamber. If there is an ink flow, there is an additional pressure drop relative to the static negative pressure level at zero flow. Pressure drop 412 corresponds to a relatively small flow rate, as might occur for a text document that is being printed, while pressure drop 414 corresponds to a higher flow rate, as might occur for a higher density image such as a photograph. In some embodiments it is found that jetting is not well controlled at too large a negative pressure (for example, due to ink starvation within the printhead), and a static negative pressure level 416 is chosen for a cut-off level where ink will no longer be supplied, because for a large pressure drop (such as 414) occurring at negative pressure level 416, the total negative pressure would be too large for proper jetting behavior. The fill level at which the tank would no longer be used corresponds to the intersection of curve 410 and level 416, i.e. the point at which the ink tank chamber is at 15% full in this example. It can be appreciated that if printing throughput were slowed down while printing high density images when the tank is somewhat depleted, the additional pressure drop due to printing flow rate would be smaller and the tank could be used for a longer time.

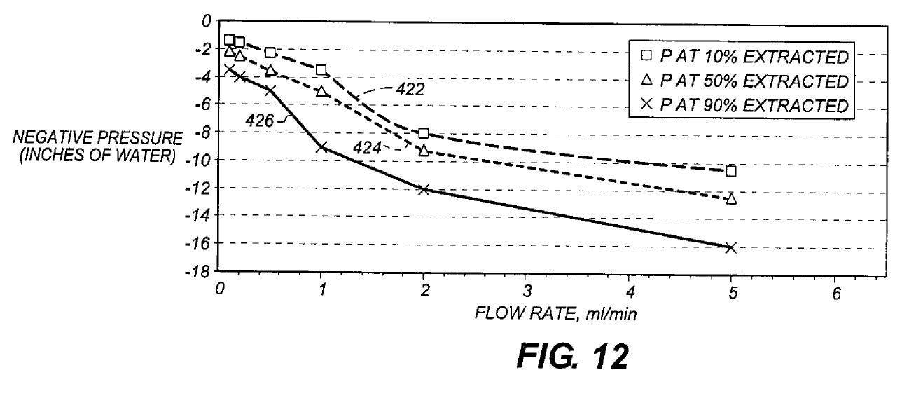

FIG. 12 shows exemplary data of negative pressure versus flow rate from an ink tank chamber for various ink fill levels. Curve 422 shows the negative pressure versus flow rate for 10% of the ink extracted (i.e. 90% fill level), curve 424 shows negative pressure versus flow rate for 50% of the ink extracted, and curve 426 shows negative pressure versus flow rate for 90% of the ink extracted (i.e. 10% fill level). If for example, it is desired not to have a negative pressure that exceeds −10 inches of water, then according to curve 422, when the ink tank chamber is 90% full, the flow rate can be as high as approximately 4 ml/minute. According to curve 424 in this example, when the ink tank chamber is 50% full, the flow rate can be as high as approximately 2.7 ml/minute. According to curve 426 in this example, when the ink tank chamber is only 10% full (90% of the ink having been extracted), the flow rate should not exceed about 1.2 ml/minute, or there will be excessive negative pressure.

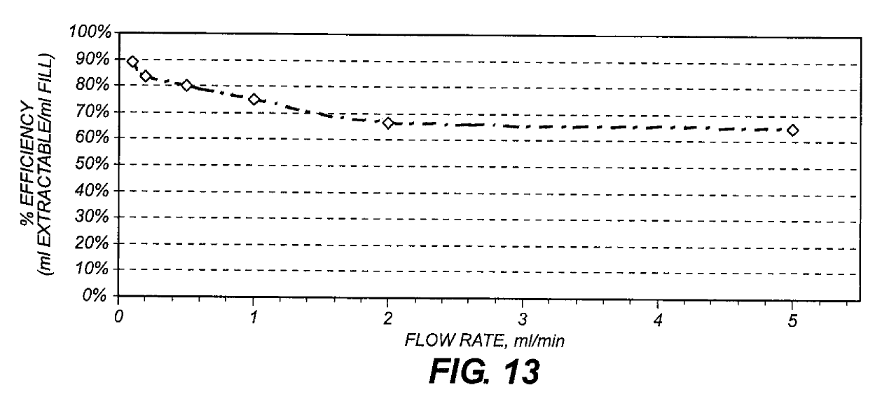

FIG. 13 shows an example of usable ink efficiency versus flow rate. The usable ink efficiency is defined as the amount of ink which may be extracted from the ink tank chamber during use divided by the amount of ink that was filled into the tank chamber. It takes into account ink trapping as in FIG. 10, as well as negative pressure effects as in FIG. 12.

The flow rate during printing is the drop ejection frequency times the drop volume times the number of jets times the duty cycle of firing. For a printhead having a nozzle array 120 with 640 nozzles that are ejecting drops of 6 picoliter volume at a drop ejection frequency of 30 kHz at 100% duty cycle, the ink flow rate is 0.115 ml/second or 6.9 ml/minute. The duty cycle for firing is based on both the image to be printed and also the print mode. Many images do not include extensive regions of 100% pixel density where all nozzles in the printhead would need to be fired. In addition, high quality printing is typically done in a multipass mode. For N pass printing, the print mask density is 1/N on the average. Thus, in the example of printing 6 picoliter drops from 640 jets at full tone density at 30 KHz, although single pass printing would result in a flow rate of 6.9 ml/minute, seven pass printing (as might be used for a high quality photograph) would only result in an average flow rate of 1.0 ml/minute from the ink tank chamber, even at 100% tone density.

For a nozzle array 130 having a smaller drop volume of 3 picoliters, the seven pass full tone density printing would result in half the flow rate (0.5 ml/minute) as the 6 picoliter example. It can be seen from FIG. 12 that at a flow rate of 0.5 ml/minute, the negative pressure differential due to flow rate (the level at a flow rate 0.5 ml/minute as compared to the static negative pressure at zero flow rate) is on the order of 1 inch of water for a tank that is 90% full (curve 422) and is on the order of 1.5 to 2 inches of water for a tank chamber that is 50% full (curve 424) or 10% full (curve 426). Again from FIG. 12, at a flow rate of 1.0 ml/minute, the negative pressure differential due to flow rate is on the order of 2 inches of water for a 90% full tank chamber, 3 inches of water for a 50% flul tank chamber, and 6 inches of water for a 10% full tank chamber. Thus it is evident that for high density images printed in a mode having relatively fewer number of passes, large drop volume and high drop ejection frequency, the pressure drop due to flow rate from ink demand in printing can be substantial. Particularly for tank chambers less than 50% full, the pressure drop due to high flow rate can be such that it could result in improperjetting, as discussed previously relative to FIG. 11. In an embodiment of the present invention, a threshold level of less than 50% of the ink reservoir capacity is set, and ink printing throughput is reduced when the ink level is below the threshold level.

U.S. Pat. No. 5,714,990 discloses a method of determining image density of a portion of an image to be printed in a swath, but other methods can be employed alternatively. The motivation for determining image density in U.S. Pat. No. 5,714,990 is to provide sufficient drying time for a highly inked printed image.

Image data from image data source 12 is processed by image processing unit 15 to specify a) the appropriate amount of ink to deposit at particular pixel locations of the image, b) the number of passes needed to lay the ink down on the media, and c) the type of pattern required on each pass in order to produce the image. In an embodiment of the present invention the image data for the image to be printed is analyzed by controller 14, e.g. by counting the drops that are to be jetted at a given rate in a portion of the image in order to calculate an ink flow demand required for printing the portion of the image. Such calculations can be done in the processing unit of controller 14 as instructed by printer firmware. In addition, the remaining ink in an ink tank chamber is monitored using, for example, the previously described sensors or monitors 1000. As schematically shown in FIG. 1 the amount of remaining ink in the ink tank chamber can be determined by sensor 1000, and a signal indicative thereof is provided to controller 14. Then, under conditions of high image density and/or low remaining ink levels in the chamber, controller 14 is enabled to cause the ink printing throughput to be adjusted and more specifically, decreased. This may be done by slowing down the drop ejection frequency (and correspondingly the speed of the printhead relative to the paper), or by changing the print mode to increase the number of printing passes. Since ink throughput or flow rate F for a particular nozzle array is equal to F=MfVd, where M is the number of nozzles in the nozzle array, f is the drop ejection frequency, V is the drop volume, and d is the duty cycle, decreasing the drop ejection frequency decreases the flow rate proportionally. In a carriage printer, the carriage velocity v=fs where s is the spacing of adjacent pixel locations in the carriage scan direction, such that the adjacent pixels are printable by the same nozzle in the same printing pass. By decreasing the carriage velocity proportionally to drop ejection frequency A, the spacing of adjacent printable pixel locations is unchanged. In other words, what is being described here is not a change in printing resolution or print density, such as a draft mode with only half the pixels being printed, but rather a decrease in the relative printing speed. This will result in a lower printing throughput, but such an occasional slowdown (e.g. for high density images when the ink tank chamber is substantially depleted) can be an acceptable tradeoff for the user because it results in less ink trapped in the ink tank chamber, and therefore a lower cost per print.

Alternatively, for high density images or portions of an image, a print mode can be used having an increased number of passes, so that the print mask density (and the duty cycle) is decreased in any one pass and the duty cycle is decreased accordingly. Similar to reducing the drop ejection frequency, this will slow the printing throughput, while preserving the print quality, resolution and density. Again, this can be an acceptable tradeoff for the user, because it results in less ink wasted in the ink tank chamber, and therefore a lower cost per print. Such tradeoffs can be particularly acceptable if the lower printing throughput only occurs occasionally for high density images when the tank chamber has been substantially depleted.

More specifically, conditions of high image density can be determined by storing a set value of ink demand in controller 14. A look-up table stored in memory included in controller 14 can provide a multiplicative factor for each ink tank chamber and each print mode based on drop ejection frequency, drop volume, number of operating jets in the corresponding nozzle array, and average print mask density. Computations and the comparisons described below can be done in the processing unit of controller 14 as instructed by printer firmware. In this method, the image data processed by image processing unit 15 can be analyzed by controller 14 as instructed by printer firmware to provide an image data density corresponding to the drops to be printed from the ink tank chamber. The image data density can be multiplied by the multiplicative factor to provide a predictive value of ink demand for an image or portion of an image. If the predictive value of ink demand exceeds the stored set value of ink demand, the ink printing throughput is adjusted and more specifically, reduced by decreasing printhead drop ejection frequency, increasing the number of printhead passes to print the image, or a combination thereof. If the stored set value of ink demand exceeds the predictive value of ink demand, then we can proceed with normal printing. The set value of ink demand can be stored in memory in controller 14 as a constant value, or it can be stored as a group of values from which the set value can be selected according to a user profile.

Conditions of low remaining ink level can be determined by storing a threshold level of ink for a corresponding ink chamber. If the ink level in the chamber, as determined by ink monitoring, is less than the threshold level, then the ink printing throughput is adjusted and more specifically reduced by reducing printhead drop ejection frequency, increasing the number of printhead passes to print the image, or a combination thereof. The threshold level of ink can be stored in memory in controller 14 as a constant value, or it can be stored as a group of values from which the threshold level can be selected according to a user profile.

In some embodiments of the present invention, the printer firmware automatically adjusts the ink printing throughput by decreasing the drop ejection frequency or by increasing the number of printing passes as a function of remaining ink and/or ink demand for the image or portion of image to be printed without requesting any input from the user. For other embodiments, user input is requested to help guide the extent to which tradeoffs in printing throughput versus ink usage efficiency are made. For example, at the beginning of a print job a user may be asked to select a level of range of tradeoffs (e.g. highest ink efficiency, fastest throughput, or an intermediate level). Alternatively, user input on such tradeoffs may be sought when the printer is installed or a new ink tank is installed. Such types of user input are referred to herein as a user profile. For printers having multiple users, in some embodiments multiple user profiles can be stored, for example, in memory in controller 14. Alternatively, a single user profile can be used for all users. For example, for a printer in the home, the parents may prioritize high ink usage efficiency for lower cost printing rather than high throughput printing, whether they are making prints or their children are making prints. Accordingly, a user can set a profile for a first user which automatically requires that an ink throughput be adjusted and more specifically reduced as described, when the remaining amount of ink in the ink reservoir is below a threshold level; a profile for a second user which proceeds with normal printing at most or all of the time, and profiles for further users in accordance with their preferences.

For printers having a multichamber ink tank such as 262 (FIG. 5), additional considerations can be important. In general, the amount of ink supplied in each chamber or reservoir 272 is selected by the manufacturer so that on average, ink will be depleted from all chambers at approximately the same time, thereby wasting less ink. However, image types printed by different users will differ. Depending on what is printed over the life of an ink tank, yellow ink may be depleted first, or cyan may be, or protective ink may be, etc. In an embodiment of the present invention, the adjusting of the ink throughput by reducing the ejection frequency and/or changing to a print mode having a larger number of passes can be triggered by comparing the amount of ink remaining in the chamber 272 having the lowest level in multichamber ink tank 262 to its threshold level, and/or by comparing the predictive ink demand to the set value of ink demand for the chamber having the lowest ink level—particularly when the chamber or chambers are substantially depleted. In other words, because the usable life of the multichamber ink tank is over when the first chamber is depleted, it can be advantageous to adjust the ink throughput particularly to conserve ink for the most highly depleted chamber or chambers. For example, if the magenta chamber still has 20% of its ink left, but the cyan chamber only has 10% of its ink left, it can be advantageous for overall system performance and efficiency, to remain at high printing throughput even for an image or image portion having high magenta density, but to adjust to lower printing throughput for an image or image portion having high cyan density.

The invention has been described in detail with particular reference to certain preferred embodiments thereof, but it will be understood that variations and modifications can be effected within the spirit and scope of the invention.

1. A method of printing comprising:
providing a printhead in fluid communication with an ink chamber;
setting and storing a threshold level of ink in the ink chamber;
monitoring a remaining amount of ink in the ink chamber;
comparing the remaining amount of ink in the ink chamber with the threshold level; and
adjusting an ink throughput through said printhead for a printed image when the remaining amount of ink in the ink chamber is below the threshold level.

2. The method of claim 1, wherein the ink chamber comprises a porous medium.

3. The method of claim 1, wherein the step of adjusting an ink throughput comprises:
reducing the ink throughput through said printhead by reducing a frequency of ink drop ejection.

4. The method of claim 1, wherein the step of adjusting an ink throughput comprises:
reducing the ink throughput through said printhead by increasing a number of printhead passes to print an image.

5. The method of claim 1, wherein the step of adjusting an ink throughput comprises:
reducing the ink throughput through said printhead by reducing a frequency of ink drop ejection, and increasing a number of printhead passes to print an image.

6. The method of claim 1, wherein the threshold level is less than 50% of a total reservoir ink capacity.

7. The method according to claim 1, further comprising:
storing at least one user profile, wherein information in said one user profile requires that ink throughput through said printhead for a printed image be adjusted when the remaining amount of ink in the ink chamber is below the threshold level.

8. A method of printing comprising:
providing a printhead in fluid communication with an ink chamber;
setting and storing a threshold level of ink in the ink chamber;
monitoring a remaining amount of ink in the ink chamber;
comparing the remaining amount of ink in the ink chamber with the threshold level;
detecting an ink demand of at least a portion of an image to be printed;
storing a set value of the detected ink demand; and
adjusting an ink throughput through said printhead for a printed image when the remaining amount of ink in the ink chamber is below the threshold level and a detected ink demand exceeds the set value.

9. The method of claim 8, wherein the ink chamber comprises a porous medium.

10. The method of claim 8, wherein the step of adjusting an ink throughput comprises:
reducing an ink throughput through said printhead by reducing a frequency of ink drop ejection.

11. The method of claim 8, wherein the step of adjusting an ink throughput comprises:
reducing an ink throughput through said printhead by increasing a number of printhead passes to print an image.

12. The method of claim 8, wherein the step of reducing an ink throughput comprises:
reducing an ink throughput through said printhead by reducing a frequency of ink drop ejection, and increasing a number of printhead passes to print an image.

13. The method of claim 8, wherein the threshold level is less than 50% of a total chamber ink capacity.

14. The method of claim 8, comprising:
storing at least one user profile, wherein information in said one user profile requires that ink throughput through said printhead for a printed image be adjusted when the remaining amount of ink in the ink chamber is below the threshold level and a detected ink demand exceeds the set value.

15. A method of printing comprising:
providing a printhead in fluid communication with a plurality of ink chambers;
setting and storing a threshold level for ink in each of the plurality of ink chambers;
monitoring a remaining amount of ink in each of the plurality of ink chambers;
comparing the remaining amount of ink in each of the plurality of ink chambers to a corresponding threshold level for the ink chamber; and
adjusting an ink throughput through said printhead for a printed image when the remaining amount of ink in one of the plurality of ink chambers is decreased below its corresponding threshold level.

16. The method of claim 15, wherein the step of adjusting an ink throughput comprises:
reducing the ink throughput through said printhead by reducing a frequency of ink drop ejection.

17. The method of claim 15, wherein the step of adjusting an ink throughput comprises:
reducing the ink throughput through said printhead by increasing a number of printhead passes to print an image.

18. The method of claim 15, wherein the step of adjusting an ink throughput comprises:
reducing the ink throughput through said printhead by reducing a frequency of ink drop ejection, and increasing a number of printhead passes to print an image.

19. A method of printing comprising:
providing a printhead in fluid communication with an ink chamber;
setting and storing a threshold level of ink in the ink chamber;
detecting an ink demand of at least a portion of an image to be printed;
storing a set value of the detected ink demand; and
adjusting an ink throughput through said printhead for a printed image when a detected ink demand exceeds the set value.

20. The method of claim 19, wherein the ink chamber comprises a porous medium.

21. The method of claim 19, wherein the step of adjusting an ink throughput comprises:
reducing an ink throughput through said printhead by reducing a frequency of ink drop ejection.

22. The method of claim 19, wherein the step of adjusting an ink throughput comprises:
reducing an ink throughput through said printhead by increasing a number of printhead passes to print an image.

23. The method of claim 19, wherein the step of reducing an ink throughput comprises:
reducing an ink throughput through said printhead by reducing a frequency of ink drop ejection, and increasing a number of printhead passes to print an image.
